(19) United States
(12) Patent Application Publication
(10) Pub. No.: US 2026/0064375 A1
(43) Pub. Date: Mar. 5, 2026

(54) SYSTEM AND METHOD FOR DYNAMIC CODE PARSING AND REAL-TIME INSIGHT GENERATION PRIOR TO COMPILATION

(71) Applicant: Abhijit Anant Telang, Maharashtra (IN)

(72) Inventor: Abhijit Anant Telang, Maharashtra (IN)

(21) Appl. No.: 18/928,408

(22) Filed: Oct. 28, 2024

(30) Foreign Application Priority Data
Aug. 29, 2024 (IN) E-2/2640/2024/MUM

(51) Int. Cl. G06F 8/33; G06F 8/41; G06F 11/00

(52) U.S. Cl. CPC G06F 8/33; G06F 8/425; G06F 8/427; G06F 11/008

(57) ABSTRACT

The present invention provides a continuous code monitoring parser integrated with a text editor that continuously monitors, analyzes a code as it is being written and displays warning texts in real-time comprising an event management block including an event generation module and a design time module, a code analysis block including a classifier module, a deconstruction module and an analysis module, a prediction block including a ML module, and an output and feedback block including a text generator and a coding style guide. The steps of dynamic code parsing by the said parser comprises code specification; keyword recognition and categorization; activation and subsequent deactivation of event generation module and design time module; activation of deconstruction module; segregation and clustering of decomposed components, utilization and impact analysis by analyzation module; predicting potential issues and calculating vulnerability scores by the ML module; and providing real-time prescriptive insights and recommendations.

### BACKGROUND OF THE INVENTION

In modern software development, code editors and integrated development environments (IDEs) are crucial tools for managing and creating complex codebases. Despite their advancements, these tools often face significant limitations in design-time analysis and error detection. As code complexity grows with intricate class hierarchies, multiple functions, and varying data structures, traditional editors struggle to provide proactive feedback. This limitation is compounded by the increasing use of generative AI tools for code generation, which can introduce inconsistencies and conflicts. Furthermore, while debugging tools offer valuable post-mortem insights, they do not address the need for real-time analysis of code changes and their potential impacts. This background highlights the challenges and gaps in current development tools and underscores the need for enhanced capabilities to support developers throughout the coding process.

The patent document U.S. Pat. No. 6,367,068B1 discloses a system for dynamic parsing that includes an editor and a dynamic parser. The editor provides for developing of source code for a computer program. The dynamic parser parses the source code as the source is developed within the editor during predetermined times (for example, in one embodiment, every second) and a file to store pre-built information, and dynamic information regarding the source code; and, a database engine to provide for querying of the file. The dynamic parser parses the source code in two stages wherein the first stage includes parsing headers and source files for class, function, and data information and a second stage that is invoked upon occurrence of a predetermined event identifies the error.

The aforementioned prior art focuses only on syntactical, language dependent error discovery and does not provide predictive and/or prescriptive insights about coding style of a specific developer along with recommendations and warning texts. able to utilize and apply the functional capability promised by a programming construct that would compile perfectly irrespective of such proper utilization and application. Prior art does not include discovery of developer's recurrent tendencies to utilize programming constructs or not so, introduce change in name, sequence, count, type and collection or individual. Another limitation of the prior art is that it does not refer to machine learning that is expected to minimize classification errors and corresponding loss modeled through a loss function. For instance, Prior art makes a distinct reference to the “risk of introducing false positives and false negatives, while missing out on true negatives” while making no mention of a loss minimization function and a suitable optimizer algorithm to minimize misclassification errors, which is typically part of any machine learning based design.

Yet another limitation of Prior art is design limits and its scope of what can be queried from database/file wherein this restriction is based on parsing what is displayed on screen at the time. It does not propose a machine learning component that would have deconstructed, learnt and discovered rules/tendencies from each line of code that has been typed or specified, and displayed warnings based on such holistic collection of historical learnings, rather than only what is currently displayed on screen. The approach proposed in prior art is focused only on syntactical error at the time of typing.

The patent document JP2016110330A provides a change influence analysis device for displaying the other request items and design items and functions in a source code that has a possibility of being changed by receiving an influence by the change of request items or design items. The device includes a change influence analysis part that inputs change source element notification indicating request items or design items to be changed, and analyzes traceability information and dependency information, and extracts elements and functions which receive an influence by the change to the request items or design items to be changed to obtain change influence destination elements, a change influence display part that displays the information of the elements and functions which receive an influence by the change at a display device on the basis of the change influence destination elements.

The aforementioned prior art does not teach about discovering uniquely personal insights about developer's recurrent tendencies to utilize, change, alter sequence of various programming constructs and using these insights in predicting the likelihood of error as and when a developer is introducing a change in code and calculating vulnerability score to generate warning texts indicating potential impact to the developer.

The patent document US2023088784A1 discloses a regression prediction platform that may obtain one or more feature sets related to an impending code change, wherein the one or more feature sets may include one or more features related to historical code quality for a developer associated with the impending code change or a quality of a development session associated with the impending code change. The regression prediction platform may provide the one or more feature sets to a machine learning model trained to predict a risk associated with deploying the impending code change based on a probability that deploying the impending code change will cause breakage after deployment and/or a probability that the impending code change will cause support issues after deployment. The regression prediction platform may generate one or more recommended actions related to the impending code change based on the risk associated with deploying the impending code change.

In the aforementioned patent document, the effect of an impending code change is diagnosed using ML models after the compilation stage and the likelihood of code breakage or support issues is predicted. One limitation of this prior art is that its applicability is restricted to the post development stage, in particular, the testing and deployment in QA and Production stages respectively, wherein a developer intends to commit code to a shared code repository. Prior art does not concern itself with “while writing the code” scenarios. This prior art does not focus on the efficiency issues of developer while utilizing the various programming constructs such as first coding and then not using functions or variables, inherent recurrent flaws in decision making where programming constructs are changed on the fly such as change in input/output parameter names, count, data types, use of collections, change in sequence etc. This prior art does not propose a real-time parsing while coding that addresses vulnerability towards an error based on a developer's propensity to make a change in a code construct.

Yet another limitation of the prior art is in its non-inclusion of developer's historic usage of programming constructs. To feed the proposed ML model, Prior art refers to Developer QA history, historical breakages, information related to code flaws or code errors historically being introduced in the code associated with developer or in code reviewed by a peer reviewer of impending code change. Prior art does not consider features such as Developer's history of using or not using code constructs, time lapse between such usage, making changes to code constructs, creating dependencies, and then breaking them through changes, creating interfering code blocks that result in unpredictable behavior, introducing opportunities for information loss through forced overwrites to variables. Prior art does not include computation of likelihood of code breakage or support issue, using inputs such as complexity of given code block in terms of number of lines, presence of iterative blocks, number of variables. It rather focuses on features such as quality of developer's session feature sets including focused or fatigued, duration of session, concurrent meetings at the same time, length of commit session and so on.

The primary limitation of existing code editors is their inability to perform real-time, design-time analysis of code from the perspective of efficiency, optimal use of code constructs, learning about tendencies of developer to make changes in the code blocks and variables and in their assignments thereof, that may result in functional or information loss, as it is being written. These tendencies to be discovered are uniquely personal to the developer and will need to be rediscovered for each user who is writing the code. This limitation prevents specification time detection of potential issues that are uniquely personal to developer, making it challenging for developers to manage code complexity, handle naming conflicts, variable type, sequence and count inconsistencies in specification and invoking respectively, and understand the impact of code changes before compilation or runtime.

Thus, there exists a need to develop a sophisticated system for enhancing code editors with real-time (specification time) analysis and feedback capabilities by integrating a continuous code monitoring parser component with editor, that goes beyond identifying syntactic errors and warnings, and provide uniquely personal insights into developer's inherent and recurrent tendencies in terms of utilizing or lack thereof concerning various programming constructs.

### SUMMARY OF THE INVENTION

It is one aspect of the present invention to provide a continuous code monitoring parser integrated with a text editor that continuously monitors and analyzes a code as it is being written in real-time.

It is another aspect of the present invention to include an event management block in the said parser comprising an event generation module that manages the creation of events and a design time module that associates and dissociates timer to track the usage or a delay in use of any given variable or code block which may include one or more conditional iteration blocks, functions, classes interfaces or any other structural blocks as permitted depending on the programming language of choice.

It is yet another aspect of the present invention to include a code analysis block comprising a Classifier Module that identifies and categorizes language-specific keywords and constructs, a deconstruction module that breaks down code into smaller components for detailed analysis and an analysis module that classifies, segregates and clusters code based on usage, dependencies, and impact.

It is other aspect of the present invention to include a machine learning (ML) prediction and prescription block comprising a ML module that learns from historical data, predicts potential issues, and calculates vulnerability score or likelihoods and prescribes preventive action wherever possible.

It is yet other aspect of the present invention to include an output and feedback block comprising a text generator that creates and displays warnings and prescriptive texts based on analysis and predictions and a coding style guide that provides real-time feedback and visualizations of code quality and usage.

It is another aspect of the present invention to provide a method of dynamic code parsing by a parser component that generates real-time insights on the quality of the code comprising the steps of defining all the parsing modules; code specification; keyword recognition and categorization into code blocks, assignments and conditional checks by the classifier module; activation and subsequent deactivation of event generation module and design time module; activation of deconstruction module; segregation and clustering of decomposed components by analyzation module; estimate utilization and impact analysis on changes in code blocks, data structures, and variables at both design and runtime; predicting potential issues and calculating resulting vulnerability scores or likelihoods by the ML module; creating a dashboard to provide insights and recommendations based on historical data and coding patterns; and offer personalized coding recommendations and warnings based on historical data using analysis and score from the analyzation and ML modules.

### BRIEF DESCRIPTION OF DRAWINGS

FIG. 1 illustrates the introduction of a parser component on the top functional layer in a language specific compiler's code as described in one of the embodiments.

FIG. 2 illustrates (a) a schema instance notifying the change in event and (b) an interface component that subscribe to changes to codeblocks, structural constructs and variables.

FIG. 3 illustrates the recognition of coding action by event generator module in the event management block as described in one of the embodiments.

FIG. 4 illustrates the event generation and handling by the event management block as described in one of the embodiments.

FIG. 5 illustrates (a) timer functionality (b) timer interface and (c) association of timer to a code construct as described in one of the embodiments.

FIG. 6 illustrates display of (a) utilization of various programming construct in a specified code and (b) elapsed time since specification according to the type of programming construct as described in one of the embodiments.

FIG. 7 illustrates summary of usage for all code blocks, data structures and variables specified in code along with color coded depiction as described in one of the embodiments.

FIG. 8 illustrates recognition and categorization of code structures as described in one of the embodiments.

FIG. 9 illustrates triggering of a decomposer after recognition of code block completion and collection of all artifacts from the code block as described in one of the embodiments.

FIG. 10 illustrates continuous monitoring of a decomposition module as and when the code being specified that gets triggered on every specification complete event, or declaration or assignment complete event and persist the code block recursively for further processing as described in one of the embodiments.

FIG. 11 illustrates deconstruction of a code block by the decomposer in the deconstruction module as described in one of the embodiments.

FIG. 12 illustrates cumulative operation of the event generation module, classifier module and decomposition module as described in one of the embodiments.

FIGS. 13A and 13B illustrates recursive collection of input parameters and output variables as described in one of the embodiments.

FIG. 14 illustrates segregation the deconstructed program code blocks and its contained components by a filter in the analysis module as described in one of the embodiments.

FIG. 15 illustrates the estimated utilization of the programming construct as described in one of the embodiments.

FIG. 16 illustrates reference linkages between given variable or code block as described in one of the embodiments.

FIG. 17 illustrates a multi-dimensional bubble chart of programming constructs after segregation based on their size (in terms of lines of code), variety (number and types of variables or structural code blocks used within once or recursively), frequency of usage, and density of reference linkages as described in one of the embodiments.

FIG. 18 illustrates a peer-to-peer comparison of change in codeblocks and forecast of scope conflicts and information loss as described in one of the embodiments.

FIG. 19 illustrates a visualization of various information collected after estimating the utilization of one or more code blocks as described in one of the embodiments.

FIG. 20 illustrates (A) the reference linkages between given code block and other code blocks and variables either referring to it directly or instances of it and (B)

FIG. 21(A-C) illustrates the warnings given to users about their historical tendency to keep the specified code blocks and variables unused based on the predictions by the ML module.

FIG. 22 (A-C) illustrates the historical likelihood of inefficient resource allocation in data structures and of variable count change or outcome variable count change as described in one of the embodiments.

FIG. 23 illustrates the functioning of a ML module as described in one of the embodiments.

FIG. 24 illustrates the triggering of change events as described in one of the embodiments.

FIG. 25 illustrates the display of various analytical results by the combined functionality of the analysis and the ML module as described in one of the embodiments.

FIG. 26 illustrates the status of any programming construct or code block or variable or data structure over time that is expressed in terms of count of incidents in each category as described in one of the embodiments.

FIG. 27 illustrates activation of a text generator due to change of events as described in one of the embodiments.

FIG. 28 illustrates generation of warning texts by the text generator due to change in code action as described in one of the embodiments.

FIG. 29 illustrates generation of warning texts by the text generator indicating of likelihood of error or adverse outcome after estimating a vulnerability score as described in one of the embodiments.

FIGS. 30 and 31 illustrates the function of abstracted query generator as described in one of the embodiments.

FIG. 32 illustrates the warning about potential information loss due to new value assignment as described in one of the embodiments.

FIG. 33 illustrates an interface component that records intention to assign or modify a given variable as a claim being set on that variable as described in one of the embodiments.

FIG. 34 illustrates a drill down component showing detailed display as user selects an option of a specific code blocks interference as described in one of the embodiments.

FIG. 35 illustrates the process flow of the dynamic code parsing by a parser as described in one of the embodiments.

FIG. 36 illustrates the impact of changing the name of a function in a code block as described in one of the embodiments.

FIG. 37 illustrates the impact of changing the assignment, sequence, type and count of parameters or variables in a code block as described in one of the embodiments.

FIG. 38 illustrates a real-time functionality of a decomposer after detecting an iterative block as it is being specified as described in one of the embodiments.

FIG. 39 illustrates a real-time warning text after detecting interfering assignments or modifications in variables impacting iteration behavior as described in one of the embodiments.

### DETAILED DESCRIPTION OF THE INVENTION

The embodiments herein and the various features and advantageous details thereof are explained more fully with reference to the non-limiting embodiments that are illustrated in the accompanying drawings and/or detailed in the following description. Descriptions of well-known components and processing techniques are omitted to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

Reference in this specification to “one embodiment” or “an embodiment” means that a particular feature, structure, or characteristic described in connection with the embodiment is included in at least one embodiment of the present disclosure. The appearance of the phrase “in an embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not for other embodiments.

Moreover, although the following description contains many specifics for the purposes of illustration, anyone skilled in the art will appreciate that many variations and/or alterations to said details are within the scope of the present disclosure. Similarly, although many of the features of the present disclosure are described in terms of each other, or in conjunction with each other, one skilled in the art will appreciate that many of these features can be provided independently of other features. Accordingly, this description of the present disclosure is set forth without any loss of generality to, and without imposing limitations upon the present disclosure.

The term “parsing component” or “parser”, are interchangeably used in the Specification where all these terms have same context and meaning as it describes a parser of the invention.

The term “codeblock” refers to a segment of code that performs a specific function or task. It often includes a set of statements or expressions grouped together, such as a function, method, class, interface, loop, or conditional statement.

The term “leaf element” or “leaf node” refers to the endpoint or the last variable in a code that has no descendent meaning it doesn't enclose any other code block or variable.

The invention disclosed herein provides a system comprising a parser component that performs dynamic code parsing and generates real-time insights on the quality of the code such that it enhances code quality by integrating real-time analysis, predictive insights, and personalized prescriptive feedback, addressing the gaps in existing code editors and development environments.

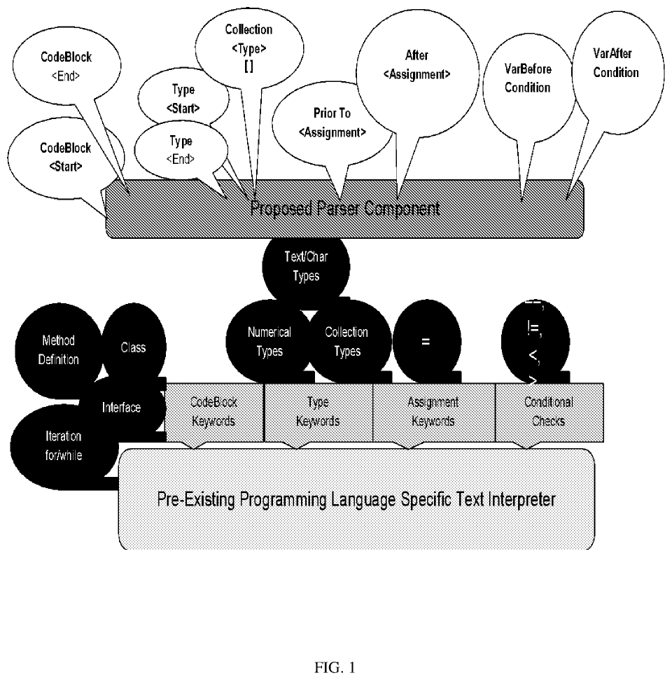

The parser component is introduced as the top functional layer in a language specific compiler's code as shown in FIG. 1. The parser component defines all the required conditions in the form of various modules such that it processes the code text as and when entered in the code editor and discovers redundancies or duplications, assignments to variables, conflicting changes in name, count, sequence, and type, utilized or idle patterns of coding artifacts including but not limited to variables, functions, classes, interfaces, iterative loops, and the like.

In an embodiment, the parser component comprises an event management block including an event generation module and a design time module; a code analysis block including a classifier module, a deconstruction module and an analysis module; a ML and prediction block including a ML module; an output and feedback block including a text generator, and a coding style guide.

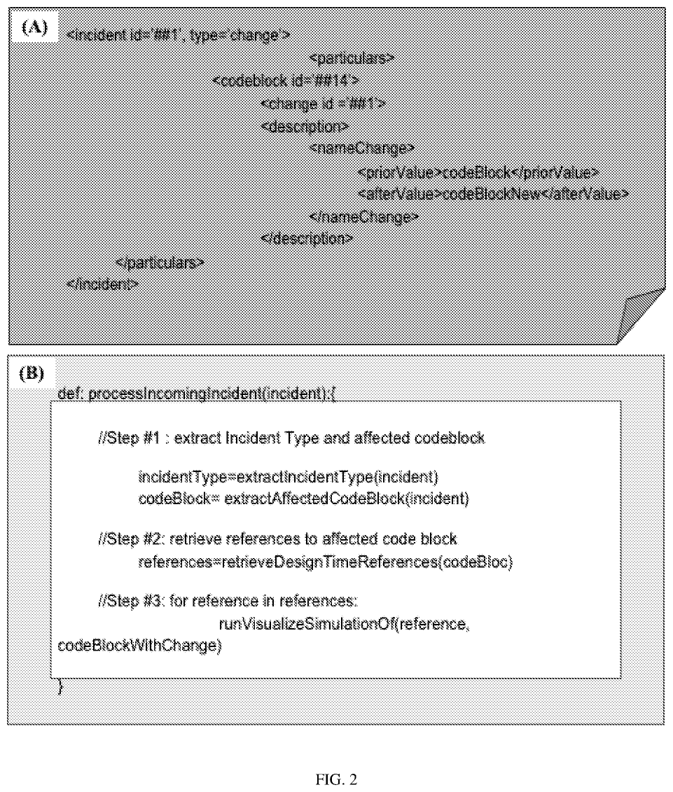

In another embodiment, the event generation module of the event management block further includes an event generator that generates event in response to certain conditions or code actions wherein the event generation generates various lifecycle events such as start/end of specification for code block, start/end of variable definition, start/end of variable assignment, start/end of type definition and the like, and an event handler that processes the event generated by the event generator wherein various events include start of specification, end of specification, start variable name, variable type and code block, and collects the distinct programming constructs into bins. In an example embodiment, FIG. 2A showcases a structured message/schema instance notifying a change in an event, and FIG. 2B showcases the event handler component that subscribes to changes in code block, other structural constructs and variable.

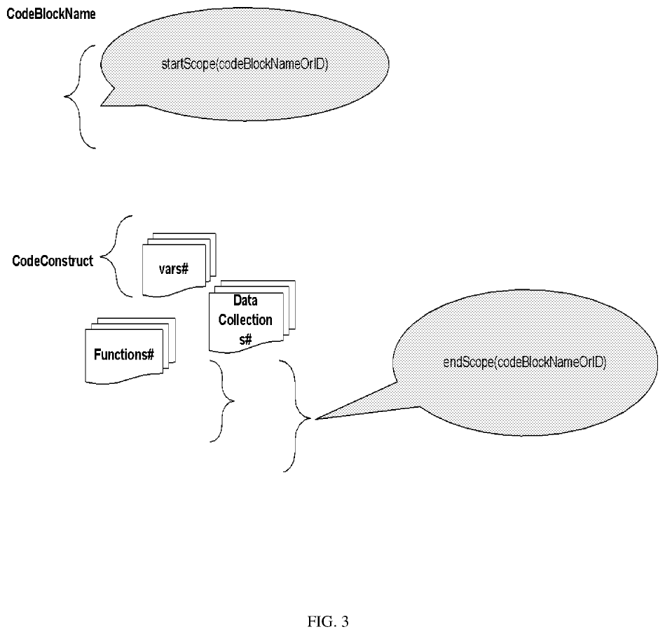

The event generation module detects the beginning and end of code blocks, assignments, type classifiers or definitions, collection specification such as whether a variable is defined as an individual value holder or a collection to hold a range of values, and conditionals by identifying language specific keywords and delimiters. In an example embodiment, the modules in the event management block starts the event after identifying and mapping a user action of typing a left open brace and ends the event after identifying a right open brace as shown in FIG. 3. Braces are only one possible example, wherein other symbols and characters are used for identification purpose.

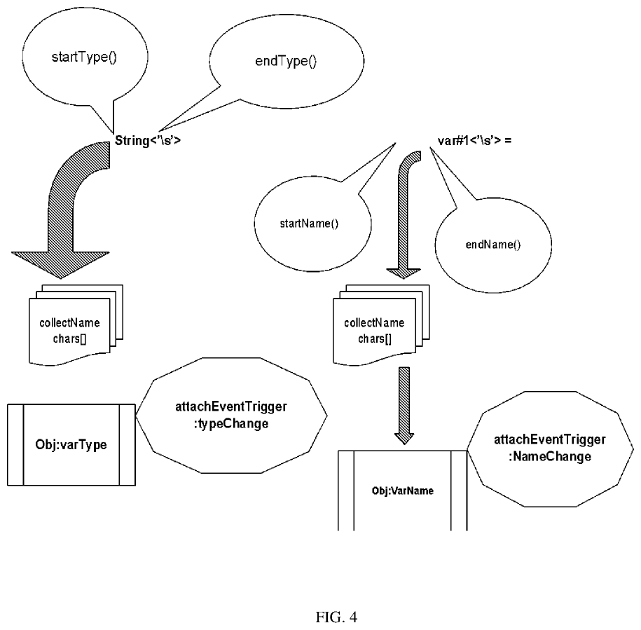

In a preferable embodiment, the conditions for event generation with respect to design actions by the event generator comprises specifying functional and/or non-functional requirements and changing/updating name of a code block and the associated variables, data type of input and output variables with its respective count. The specification condition also includes technical, interface and use case specifications. In an example embodiment as shown in FIG. 4, specifying includes specifying name and data type of but not limited to variable, class, interface and functions in a code block; name, count and data type of input variables, and its respective output variables.

In yet another embodiment, the design time module including one or more timer is implemented at the start of specification or assignment of a code block or its contained components such that it gets associated with the code block or its contained components as it detects a matching closing delimiter including indentation, curly braces, angle brackets, square brackets, tags and the like. Each timer ticks until it detects an actual reference to the concerned code block or variable or data structure. The timer tracks how long each component remains unused or active, giving insights into its utilization.

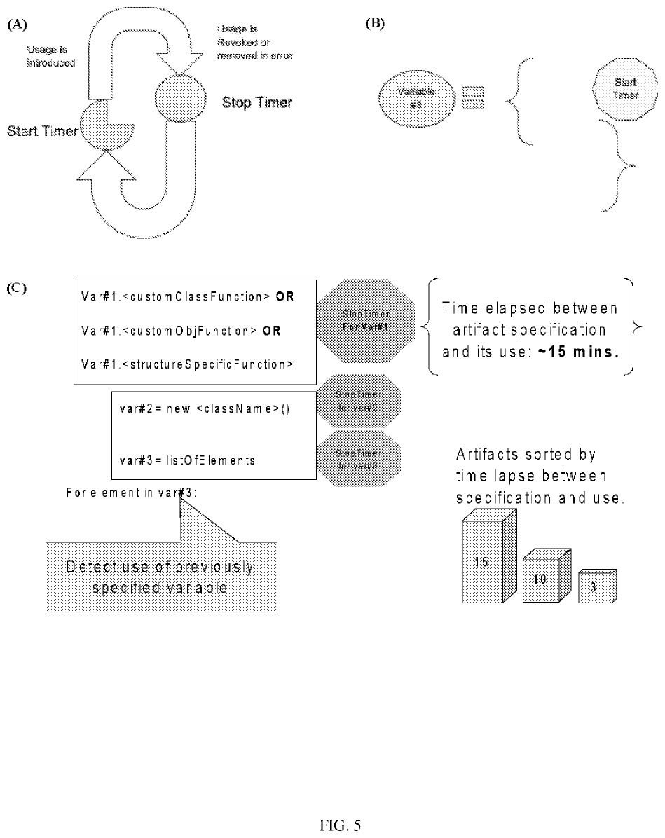

In a specific embodiment, the design time module functions by timer initialization such that a timer attaches to a code block and its contained components and/or a data structures, timer start for code blocks when a syntactical construct is completed and for variables when they are assigned a value directly or indirectly, timer stops when the component (code block/variable) is used (FIG. 5A) and the timer restarts when a component is removed or no longer used until it is utilized.

In an example embodiment, a timer initializes and starts on detecting a closing delimiter (parentheses) indicating the completion of a code block or its contained components as shown in FIG. 5B and stops as it discovers an assignment or invocation of a code block, or its contained components as shown in FIG. 5C. The timer resumes on removal or revocation of usage of a code block, or its contained components until it detects the next instance of specification. Example: Removing a function call ‘calculateSum( )’ from the code will restart its timer the next time ‘calculateSum( )’ is invoked.

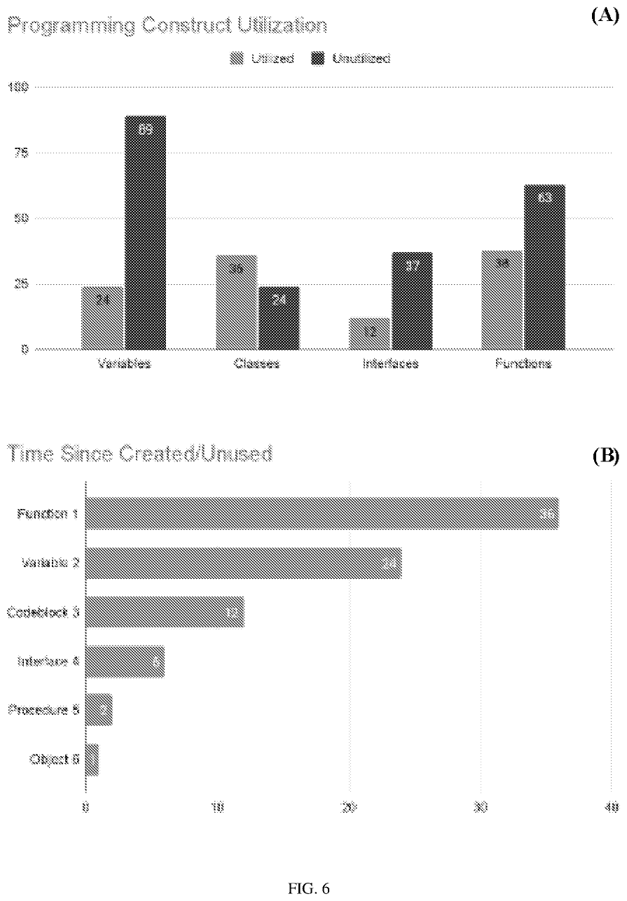

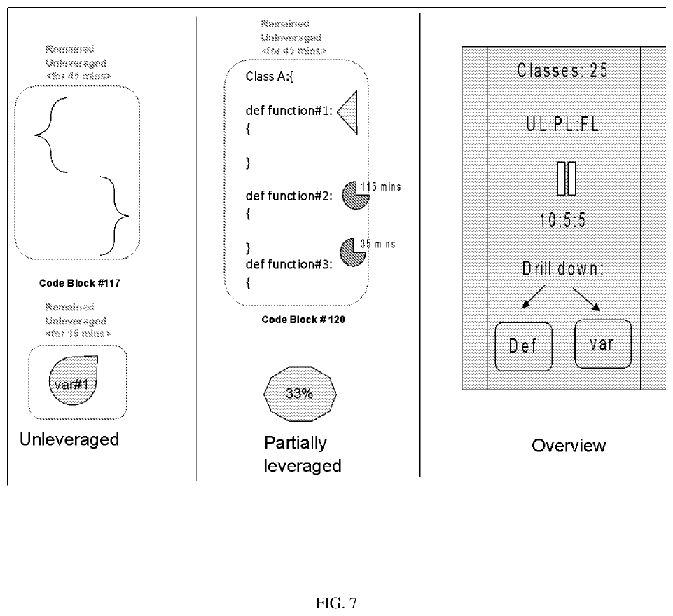

In a specific embodiment, the duration between specification of a code block or its contained components and its use is computed as elapsed time such that it enables the identification of idle or abandoned code blocks and its contained components and provide reports to the user as shown in FIGS. 6A and 6B to avoid creation of new code blocks and its contained components. The components marked with timers that have been running throughout the session as “unleveraged” or “unused” is coded with a specific color. In an example embodiment, the FIG. 7 showcases summary of usage for all code blocks, data structures and variables specified in code along with color coded depiction of each individual code block or variable or data structure and corresponding time elapsed in given state.

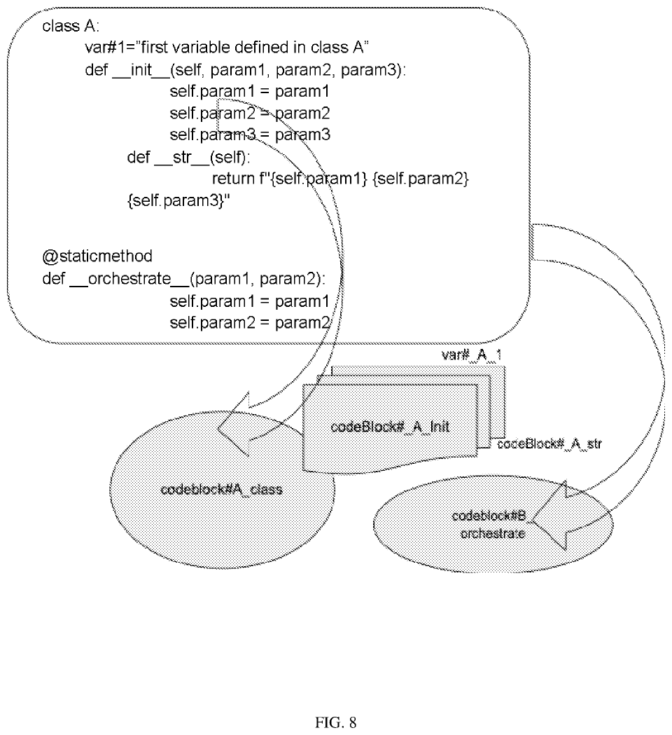

In other embodiment, the modules of the code analysis block are disclosed. The classifier module uses programming constructs to identify and categorize code blocks into but not limited to function/method block, class block, struct block, interface block, namespace block, conditional block, loop block, exception handling block, anonymous function/lambda block, generator block, coroutine block, macro block, attribute/annotation block, statement block, and initialization block wherein each code block and its contained components is categorized into types such as function, class, struct, interface, loop, conditional, exception handling, and the like. The classification/categorization of these code blocks is according to the grammar rules of the language being parsed wherein the structural constructs like loops and conditionals in a code block are identified by delimiters including parentheses or brackets, assignments are identified by symbols including an equal sign (=) and conditional checks are identified by keywords including logical and equality operators. The classifier module uses machine learning algorithms either supervised or unsupervised to match keywords to predefined functional categories based on similarity metrics. In an example embodiment, FIG. 8 showcases how a classifier module disseminates different code structures including classes, interface, stand-alone functions, or methods into collection of code blocks.

In an example embodiment, an assignment is split into a value and a variable or data structure by detecting the assignment related keyword like “=” wherein the value succeeds the said keyword and the variable or data structure precedes the said keyword. The said variable or data structure is further identified using program specific keywords including but not limited to declaration keywords like int, float, double, string, Boolean; keywords in iterative loop like while, for, do-while, for-each; and its defined name. The said values include constants and expressions wherein constants include numerical, string or character, or alpha-numerical constants and expressions include logical or Boolean, numerical or string comparison and invocation of a code block.

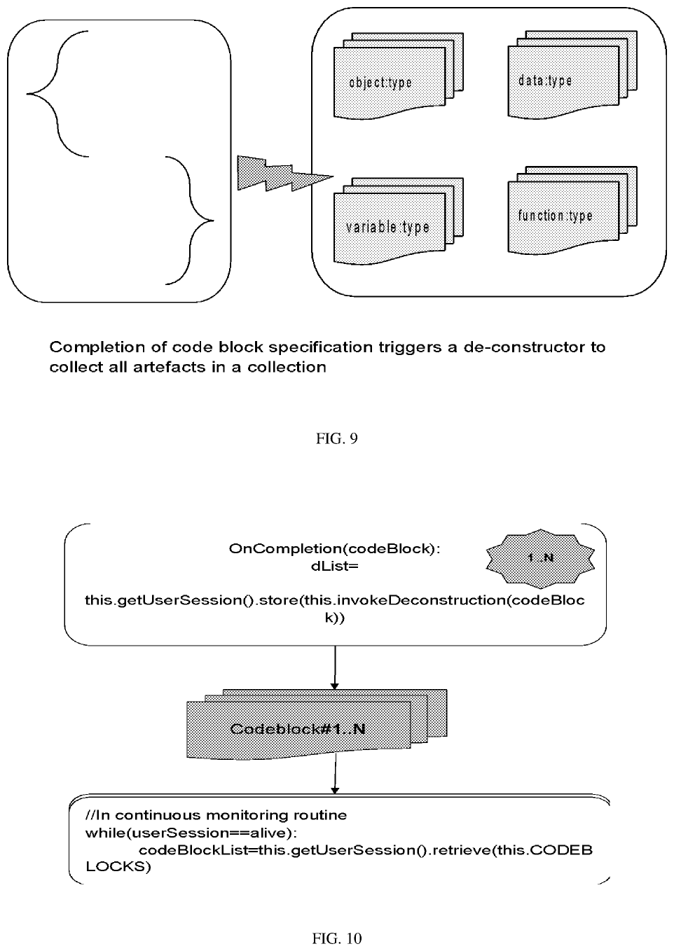

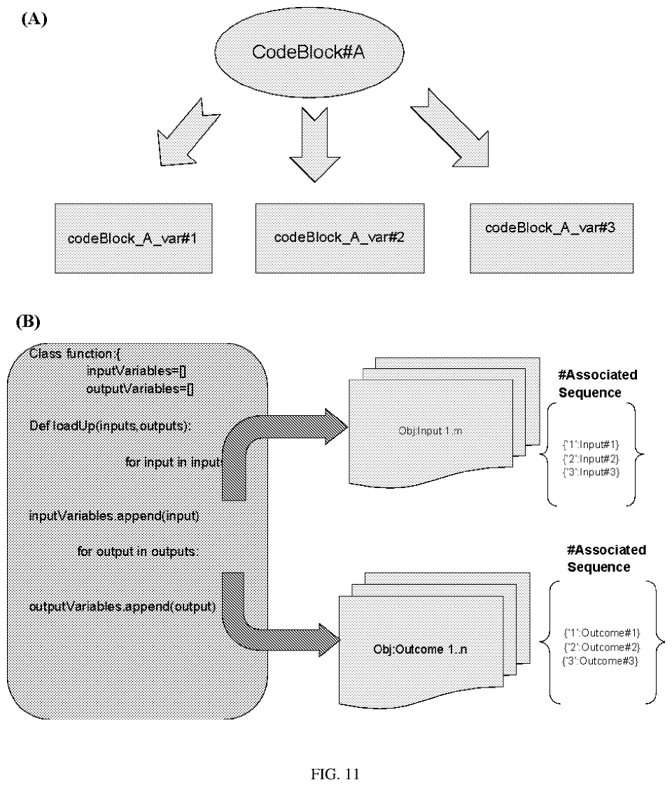

In yet other embodiment, the deconstruction module includes a code decomposer and/or a tokenizer that is triggered after completion of a code block by program-specific delimiters including indentation, curly braces, angle brackets, square brackets, tags and the like as shown in FIG. 9. The code decomposer divides or breaks down a complex code into several small manageable code blocks as shown in FIG. 10 whereas a tokenizer breaks down each code block into several meaningful units and contained components called tokens including variables, functions, data structure collections including lists, arrays and dictionaries, keywords, identifiers, operators and literals wherein the tokenizer includes lexer and/or string splitter that further tokenizes assignments and conditional checks. The said meaningful units are determined by the previously learnt programming language specific keywords that identifies and typecastes various programming constructs such as variables and code blocks. These are either learnt by the classification block or borrowed through the language specific code editor as the later recognizes and highlights the language specific keywords and constructs.

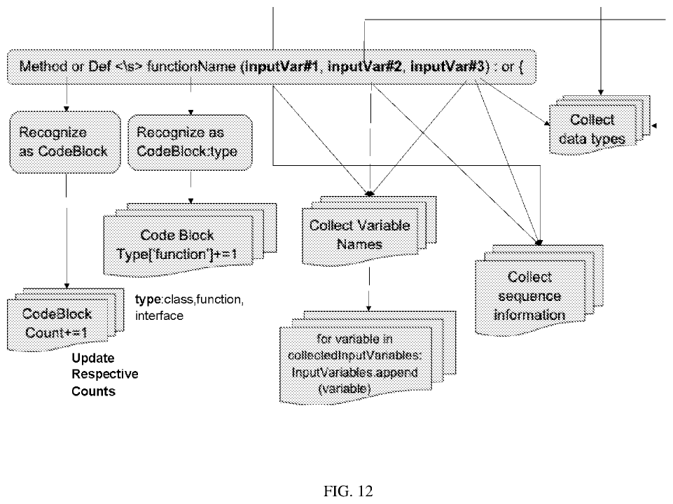

The deconstruction module is self-reflective such that it decomposes each functional code block till it encounters the leaf node in a code structure as shown in FIG. 11. The deconstruction module monitors the specified code blocks continuously and are triggered on completion of every event generation during specification, declaration or assignment and persists the specified code block and its contained components recursively for further processing.

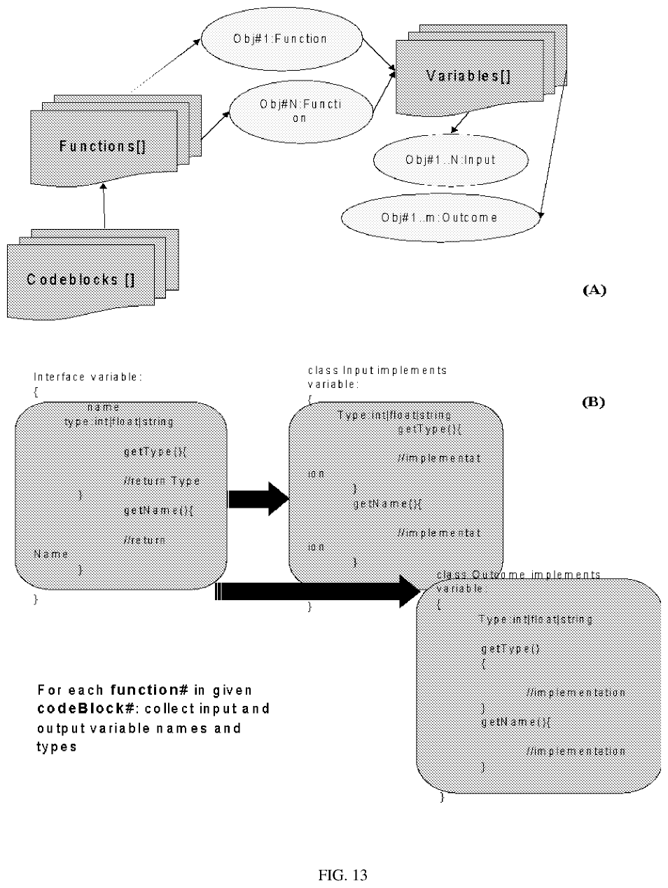

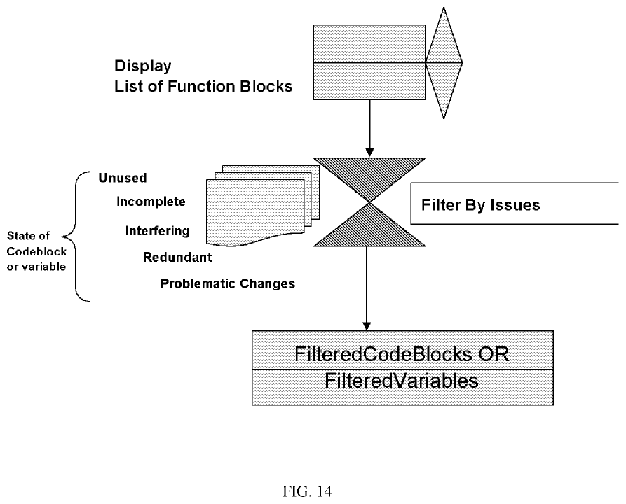

In an example embodiment, FIG. 12 illustrates the subsequent operation of the event generation module, classifier module and decomposition module wherein the line of code that specifies functional declaration generates an event, followed by interpretation and classification of code by the classifier module and its corresponding decomposition into code blocks and variables. In yet another example embodiment, FIG. 13A showcases the inter-relationship between codeblocks, contained functions or methods and corresponding input parameters and outcome variables, and FIG. 13B showcases and interface component that is implemented to model components of a given codeblock, namely the input parameters and outcome or output variables.

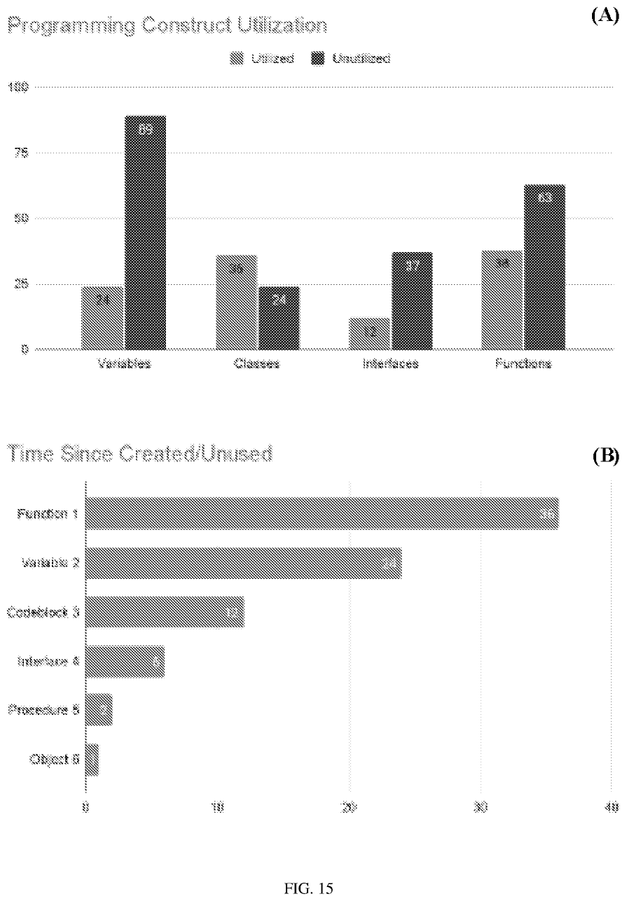

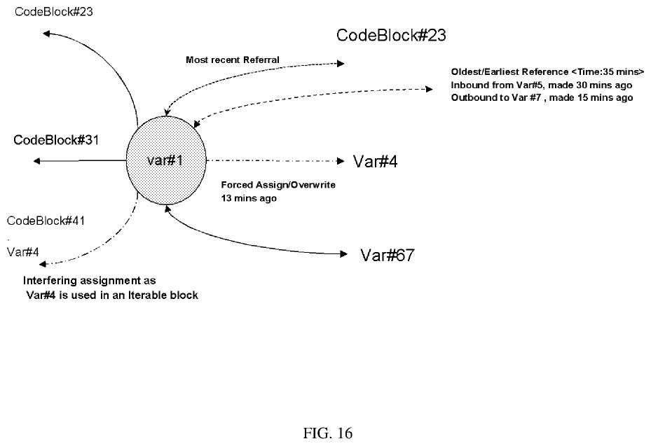

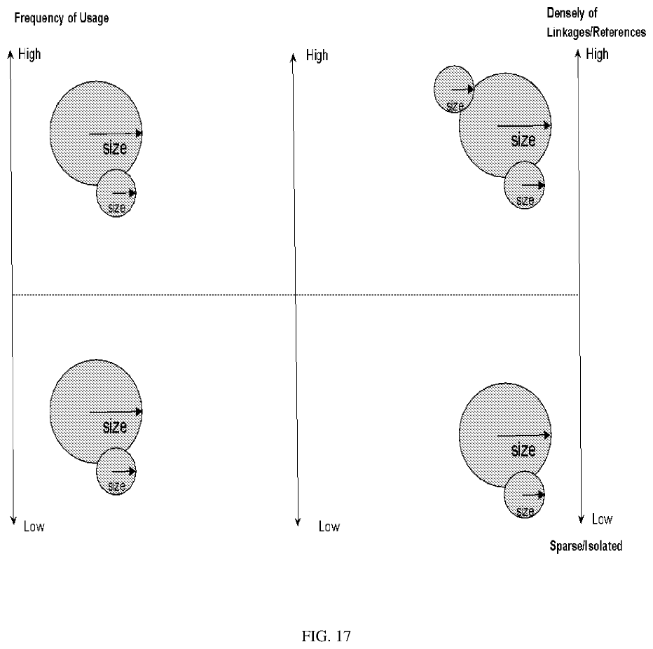

In another embodiment, the analysis module includes a filter and an analyzer wherein the said filter segregates the deconstructed program code blocks and its contained components based on usage, complete and incomplete specification, interference, redundancies and impactful changes as shown in FIG. 14 and the said analyzer estimates the utilization of the segregated code block and/or its contained components as shown in FIG. 15 by collectively clustering the code block or variable based on one or more criteria such as but not limited to completion or usage or idle time, with its associated code block or its contained components and marks each category with a color-coded tag as shown in FIG. 7. The code blocks are clustered into functional blocks based on their interdependence including densely interlinked, sparsely interlinked, completely independent, indicating mutual dependence, minimal mutual dependence and self-contained blocks, respectively or one-way dependent blocks, and frequency of usage including most frequently used or sparsely used as shown in FIG. 16.

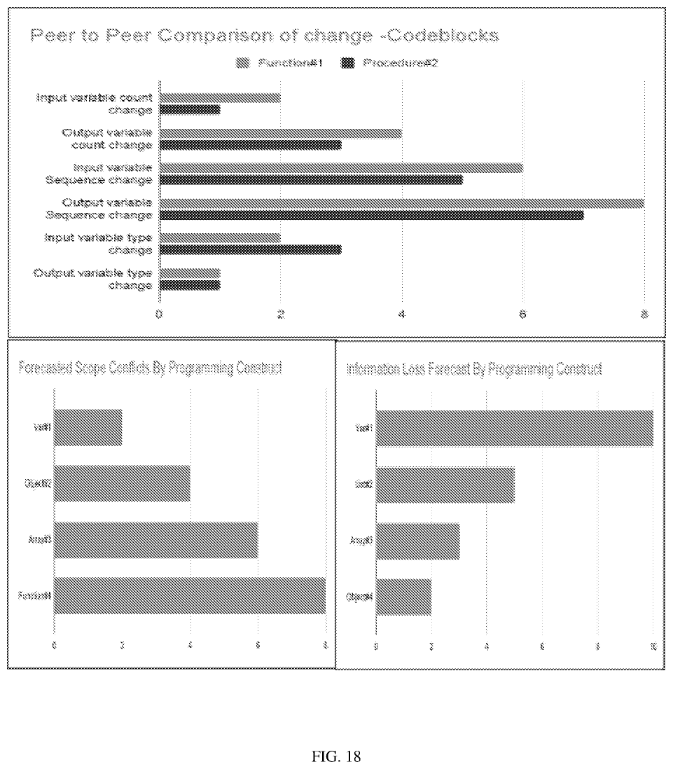

In an example embodiment, FIG. 17 represents functional blocks as bubbles, with size proportional to their content wherein a large bubble for a class indicates a class with many methods and variables compared to a smaller bubble indicates a class for a simpler function.

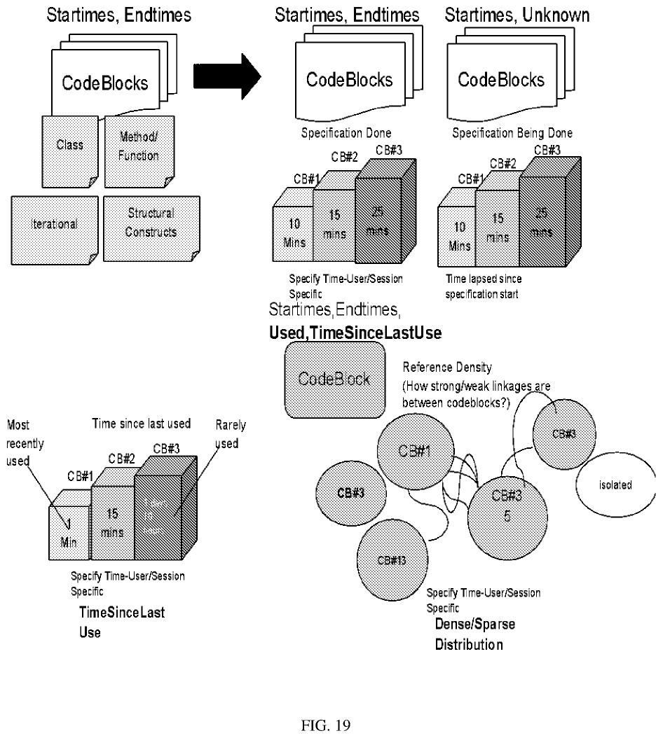

In a specific embodiment, the analyzer records the utilization of assigned components including unused blocks, variables based on its associated timer, estimates the linkages between each code blocks and provides an estimated density between the linkages, and performs impact analysis on change to code block based on magnitude and extent of usage and the respective interference in the function of the impacted code block wherein the impact analysis for each change event and assignment or removal of values or linkages includes the forecast of potential unknown variable or code block errors, the identification of reference connections that may be lost due to inadvertent changes, the assessment of potential duplicate or scope conflict issues, the evaluation of possible information or functional loss due to type incompatibilities resulting from the change and the anticipation of potential information or functional loss arising from forced value assignments, removals, or revocations as shown in FIG. 18. The initiation to change a code block is detected by changes in name, count, value, type, collection, sequence, relationship, wherein the relationship change includes change in containership/association with other code blocks.

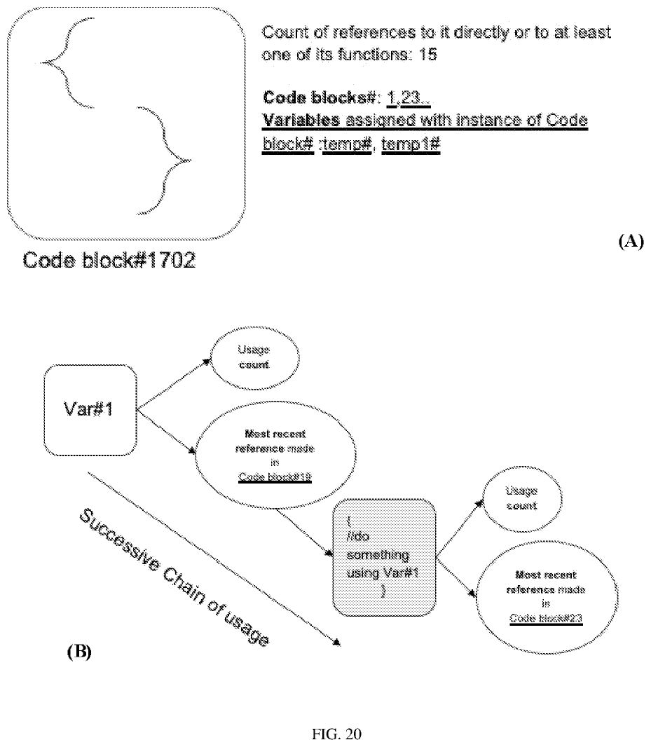

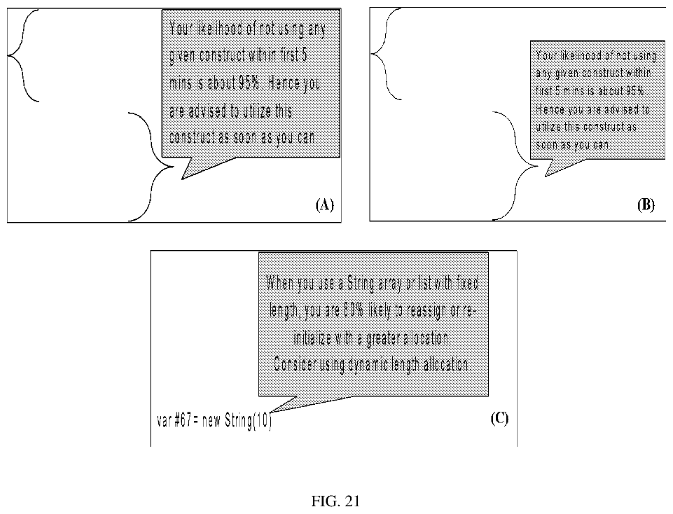

In an example embodiment, the estimation of utilization of one or more code blocks from a code as shown in FIG. 19 includes segregation of code blocks for which specification is complete and incomplete wherein an incomplete specification denotes that a closing delimiter is not yet detected by a timer. The segregated code blocks are further broken down into smaller code blocks and its associated timers are analyzed to compute the elapsed time since usage. The utilization analysis also includes segregating and clustering reference linkages between the code blocks into densely interlinked and/or sparsely interlinked code blocks. FIG. 20A depicts the reference linkages between given code block and other code blocks and variables either referring to it directly or instances of it. FIG. 20B depicts a chain of successive references between variables and codeblocks and the usage count of each variable or code block and the most recent reference and use of it.

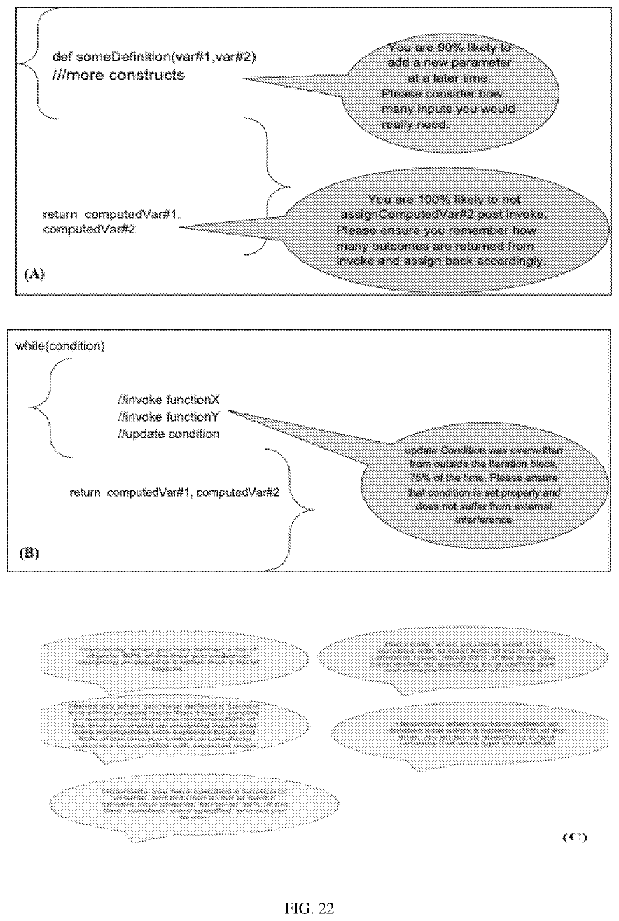

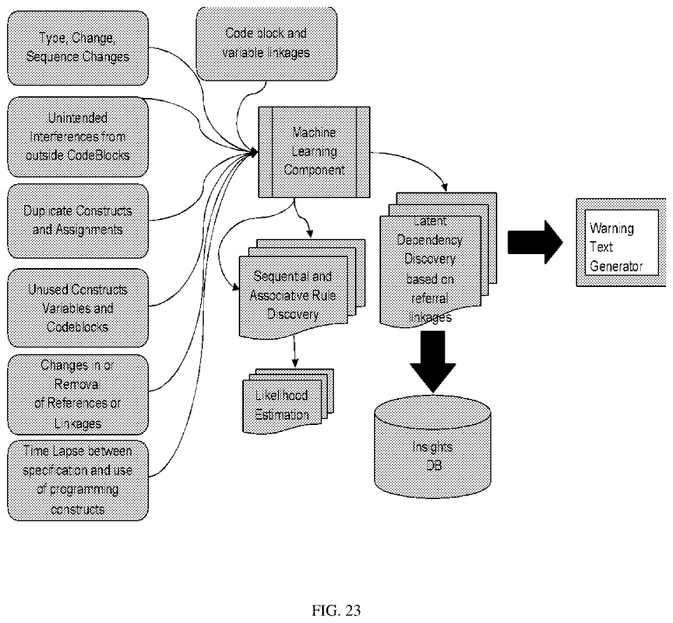

In another embodiment, The ML module in the ML prediction and prescription block is configured to learn about sequence, co-occurrence, and correlation of timers while specifying code blocks, and variables along with their respective count, and type, and their usage in assignments, computations, transformations, and iterations as and when needed. It analyzes usage patterns in assignments, computations, transformations, and iterations and predicts/assess the likelihood of information loss, functionality loss, compilation and/or run-time errors, and/or interference among code blocks and variables, predicts potential issues and warns about the potential impact to the code designer wherein the potential issues include idle or unused code blocks or variables, type incompatibilities, sequence and count incompatibilities, forced or inadvertent overwriting of variable values resulting in information or functional loss and interference in other code blocks or variables which may be referencing given variable or code block, loss or unforeseen mutation in reference linkages between dependent variables or code blocks resulting in unstable or unpredictable outcomes. The analyzer and ML module work together such that the cumulative impact created by various designer actions are presented in real-time to the user. In an example embodiment, FIG. 21A-C showcases the warnings given to users about their historical tendency to keep the specified code blocks and variables unused based on the predictions by the ML module. FIG. 22A-C showcases the historical likelihood of inefficient resource allocation in data structures and of variable count change or outcome variable count change.

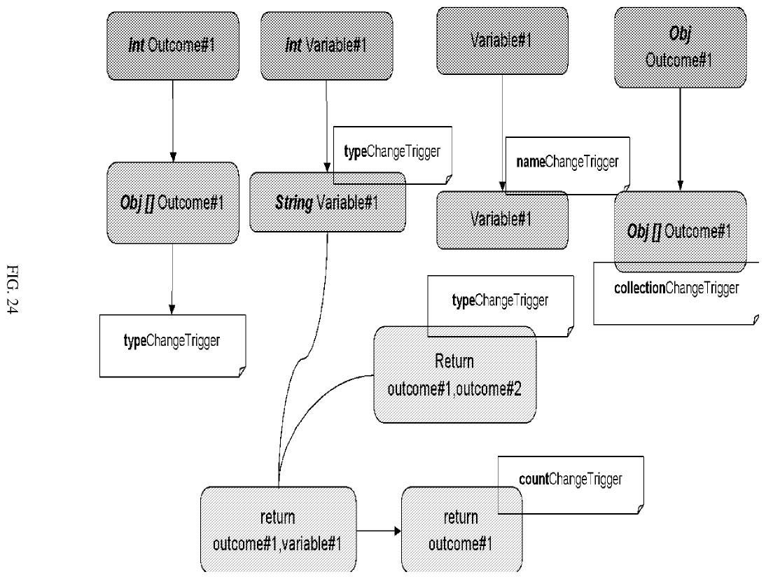

In a specific embodiment, the ML module uses any known classification algorithm such as logistics regression or a decision tree or a random forest or support vector machines or a neural network that is used to model and interpret rules regarding code block vulnerabilities, such as name changes or type conflicts and logistic regression that quantifies the probability of errors based on various factors. The model discovers rules about the type or kind of code blocks or variables that are more vulnerable to information loss, functionality loss resulting from forced or inadvertent assignments, unintended conflicting interferences from other variables or code blocks external to impacted code block or variable, and change in events including name change, sequence change, number of variables change, change in individual variable or collection of variable and data type change as shown in FIG. 23.

The independent factors that are used by ML module to learn and determine the odds ratio of occurrence include count of input parameters, count of output parameters, count of unique types used within a code block, proportion of collection variables and non-collection variables, presence of an iteration block with its own set of local scope variables and historical odds ratio of past errors wherein the collection variables include array, list, array list, dictionary, hashmap, set, hashset and the like. Here, the odds ratio indicates a tendency to create duplicate naming for variables/code blocks versus not so, create badly designed control loops, versus not so, create programming constructs and abandon them later versus not so, create unstable/erratic iterations over data structures wherein control variables are allowed to be mutated from outside iteration, create circular references if any versus not so, uneven burden versus not so, on some constructs versus others wherein the burden is expressed in terms of number of variables and its assignments, and functions, code lossy or incompatible type casting that results in information or functional loss due to abrupt type change versus not so and write similar functions across classes without moving them into a cleaner interface implemented by multiple classes in question, versus not so. By evaluating the odd ratio of occurrence, the ML module estimates a vulnerability score for type incompatibility wherein the

In an example embodiment, the list of independent factors as shown in the Table 1 are used to calculate the said vulnerability score using a formula (1):

$$Vulnerability score = ln ( Odds ratio ) = ( k 1 * NumVar + k 2 * NumTypes + k 3 * PropCollectionVar + k 4 * HistOddsRatio )$$

wherein,
k1, k2, k3 and k4=coefficient factors generated by the ML module after successive learning and training,
Num Var=Number of variables or parameters used, (these can be separate factors, independently considered in the model)
NumTypes=Number of types used within function,
PropCollection Var=Proportion of collection variables
wherein, PropCollection Var=(No. of collection variables)/(No. of collection variables+No. of individual variables)
HistOddsRatio=Historical Odds Ratio of Change Events indicating historical likelihood of given user to make a change post specification.

TABLE 1
Examples of independent factors used by ML module that is Ranked
Descending based on Odds ratio of likelihood of event.

| | | | | | | | Historical |
|---|---|---|---|---|---|---|---|
| | | | | Number of | Proportion | Presence | Odds Ratio of |
| | | | Number of | types used | of | of an | Type Change |
| Code block | Count of | Count of | variables | within | collection | iteration | Events - Code |
| Name | Inputs >1 | Outputs >1 | used | function | variables | block | block wise |
| Function#1 | 4 | 2 | 10 | 10 | 2:5 | TRUE | 9:1 |
| Function#2 | 3 | 3 | 5 | 4 | 1:5 | FALSE | 1:3 |
| Function#3 | 2 | 2 | 3 | 2 | 1:1 | TRUE | 1:5 |

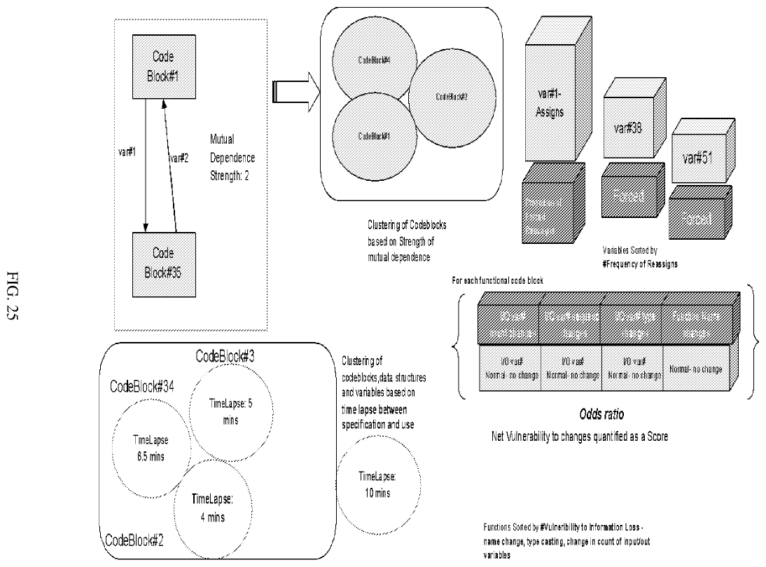

In another example embodiment, separate ML models are constructed and trained for each change event type such as name change, count change, sequence change, collection change, data type change and so on for each user as shown in FIG. 24

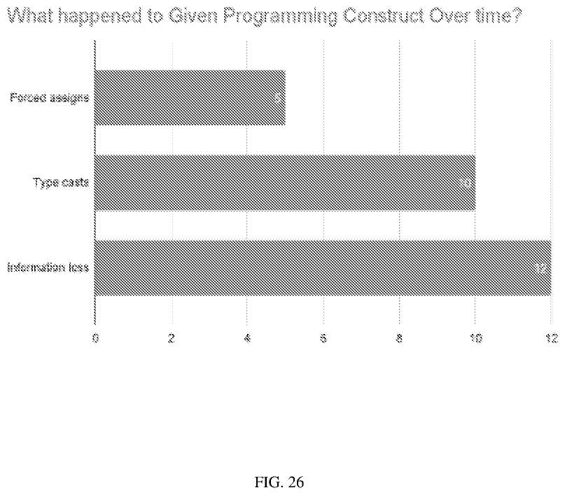

In an example embodiment, the real-time integration of the analyzation and the ML modules in the parser component is disclosed. As shown in FIG. 25, the analysis module clusters the deconstructed code blocks based on the strength of dependencies including no dependance, one way dependence or mutual dependance, and on the estimated time lapse between specification and its usage whereas the ML module estimates the likelihood of error due to forced assignment and reassignment, and sorts out the vulnerability score to information loss due to removal or changes in dependency linkages, and change in events due to the respective change in name, sequence, collection type, data type and count of a variable or code block and/or its contained component. The FIG. 25 also represents the reference linkages between each deconstructed code block, each assignment, and each cluster.

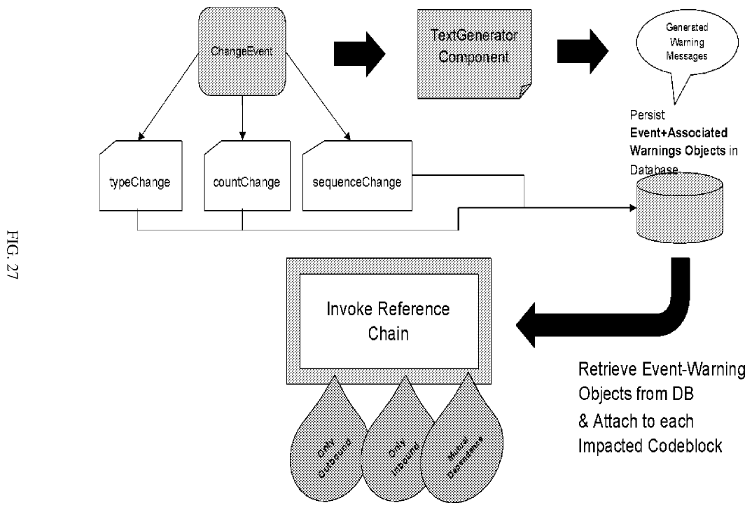

In yet other embodiment, the modules of the output and feedback block is disclosed. The text generator generates warning texts after impact analysis by the analyzer and ML module wherein the said warning texts includes insights retrieved from the impact analysis stored in the database. The warning texts are displayed either automatically in real-time as and when an impact on code is detected by the parser component or on demand via key based, visual point and click device based including a mouse, or voice or gesture command prior to code compiling process. The warning texts includes the issue descriptions, source of issue, and location of issue of the impacted code block and/or its contained components. It also includes the likelihood of given user repeating the past mistakes or introducing logical errors based on past historical tendencies. The warning texts can be personalized to provide prescriptive forewarning by interlinking the text generator with that of the analysis and ML module such that the ML models recognizes historical coding patterns involving forced or inadvertent assignments, mismatching I/O parameters in terms of count, type, sequence and individual variable or collection of variables, interference in iterative code blocks, uneven referencing burdens indicating unequal distribution of reference linkages on code blocks or variables and prescribes the user with likelihood of run-time error through the real-time warning texts. In an example embodiment, FIG. 26 represents the display interface indicating the status of any programming construct or code block or variable or data structure over time that is expressed in terms of count of incidents in each category.

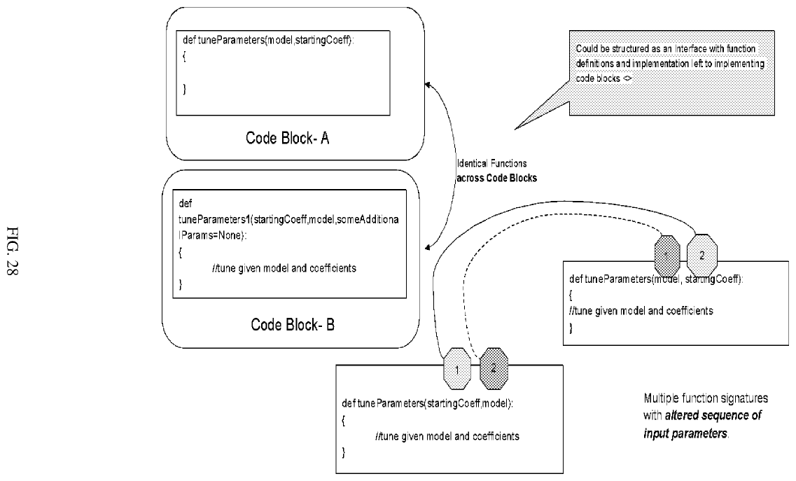

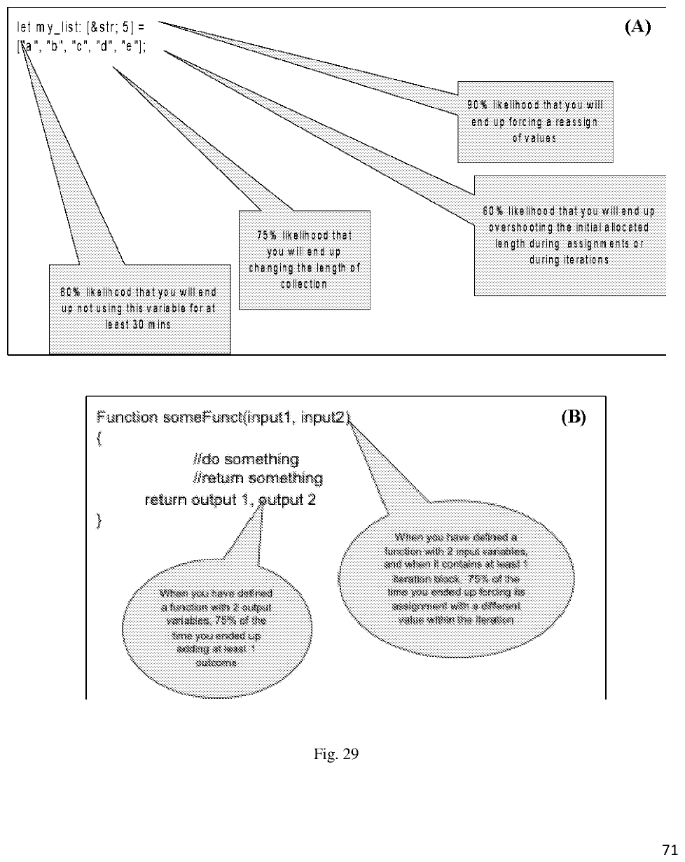

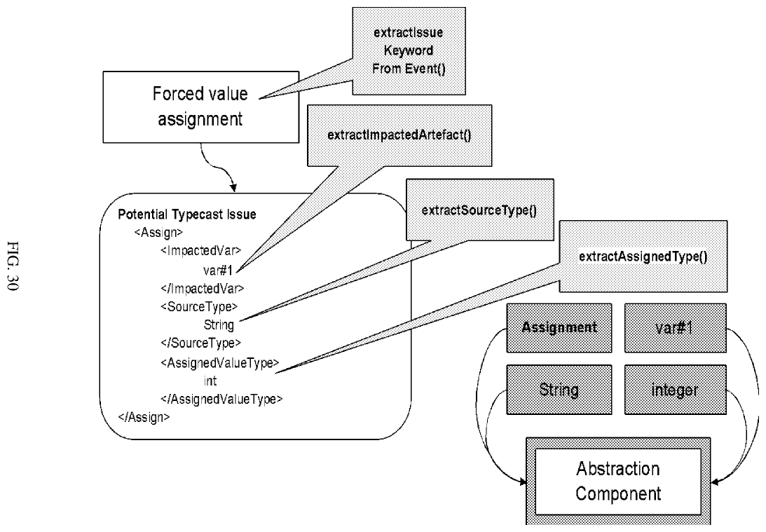

In an example embodiment, FIG. 27 showcases how a change of events triggers the text generator to generate warning texts and apply such warnings to each impacted code block or variable or data structure, for a given event trigger. In yet another example embodiment as shown in FIG. 28, warning text is generated when there is alteration in specified sequence of input parameters wherein the alteration in the sequence may end up in compilation and run time error and the same is depicted in the warning text to the user. In yet another example embodiment, the warning texts indicating of likelihood of error is generated after the ML module estimates a vulnerability score using the aforementioned formula (1) as shown in FIGS. 29A and 29B.

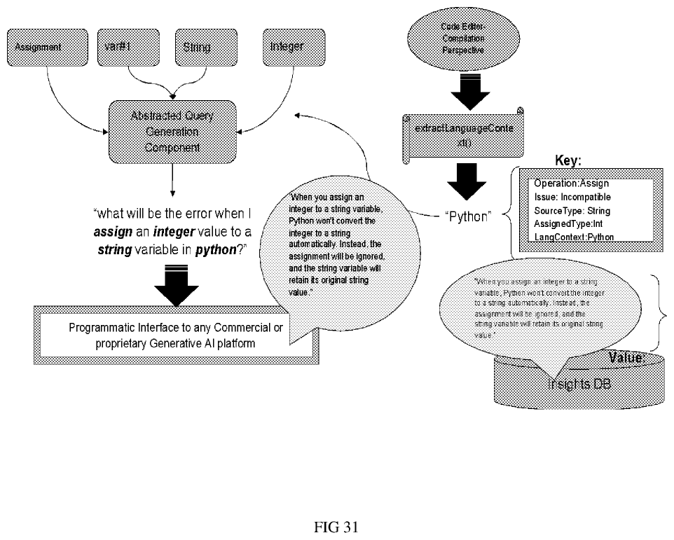

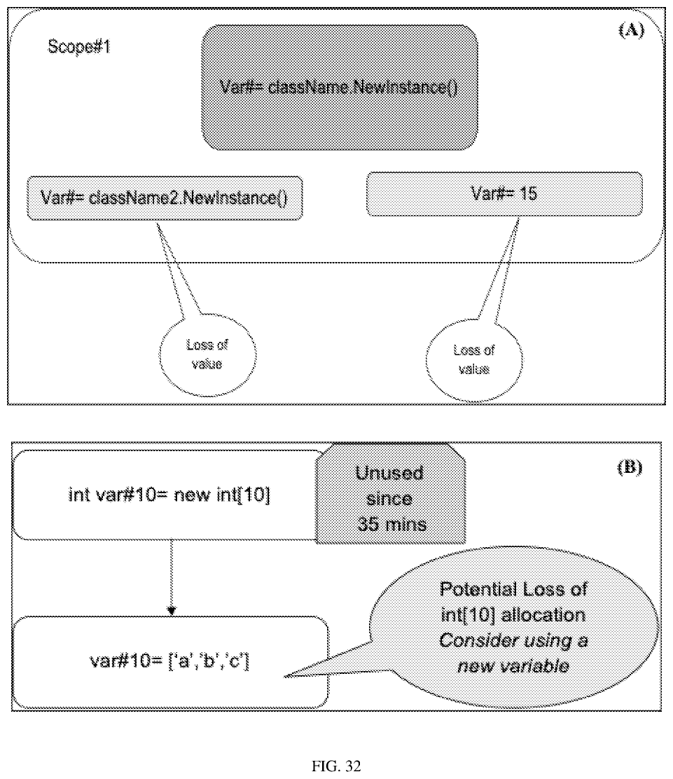

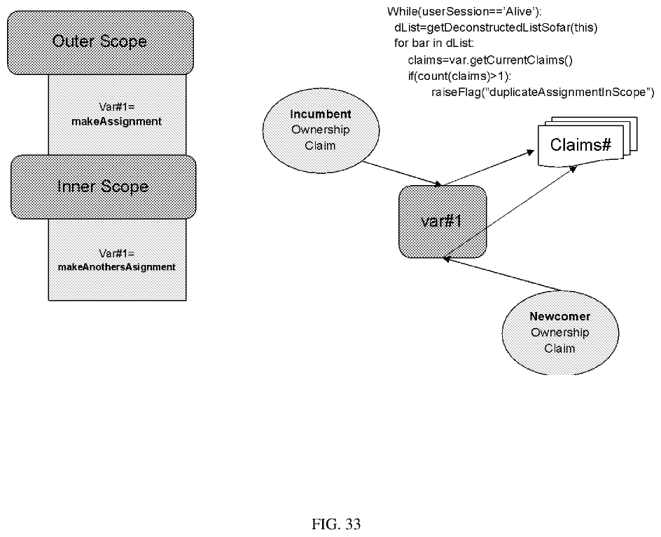

The warning texts are generated either by introducing a tool specific programming interface that poses queries by first uploading language specific compilers help documents to commercially available generative AI tooling and training the generative AI tooling on such proprietary documents or by abstracted query generator from the foreseen errors or issues of various genres by the inbuilt ML module as shown in FIG. 30 and FIG. 31. In an example embodiment, FIG. 32 illustrates the warning about potential information loss due to new value assignment without utilizing previous assigned value to given variable based on the predictions by the analysis and ML module such that the previously assigned object can be lost. In another example embodiment, FIG. 33 illustrates scope conflicts based on change in value assignment. It indicates the interface components that records intention to assign or modify a given variable as a claim being set on that variable. The claim is like a privilege token that is held only by controlling code block or variable such that the conflicting claims are identified simultaneously. It is however different from thread synchronization or coordination. It is not about letting one assignment or modification operation at a time but rather about warning conflicting or interfering changes irrespective of whether they are sequential or not, whenever such an attempt is being made at specification time.

The coding style guide includes dashboard with dashlets that are created using webserver components wherein the frontend and backend components are integrated using IDE. The coding style guide is generated in real-time as per the functionalities of the ML module and the analysis module. The style guide is used to visually present all the analyzed and interpreted data from various modules and the prescriptive warning texts, bar charts and trend charts from the available data in the libraries wherein the data are accumulated by the clustering studies, frequency and sequence analysis, recurrence analysis, likelihood analysis based on causation and co-occurrence of events by the respective analyzation and the ML module.

In a specific embodiment, the coding style guide comprises insights on the users tendency to create duplicate naming for variables/code blocks resulting in scope conflicts, to code Lossy or incompatible type casting that is resulting in information or functional loss due to abrupt type change, to write similar functions across classes without moving them into a cleaner interface implemented by multiple classes in question, to create badly designed control loops, to create programming constructs and abandon them later, to inadvertently create circular references, to create unstable/erratic iterations over data structures wherein control variables are allowed to be mutated from outside iteration, and to create uneven burden on some constructs versus others where burden is expressed in terms of number of variables and assignments, and number of functions and number of interdependencies expressed in the form of count of references to variables or code blocks.

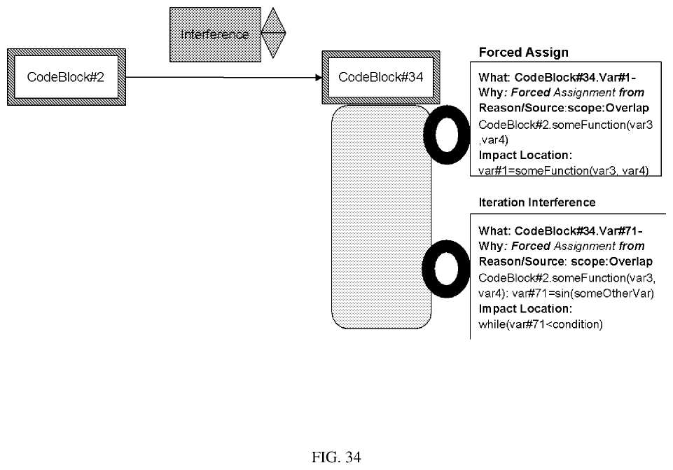

In yet another embodiment, the output and feedback block further includes a filter component that allow users to filter predictions and issues categorized into utilized/unused, specification complete/incomplete, whether suffering from interference or causing interference, redundant or duplicate, isolated versus densely connected, either by text or voice commands to view specific insights and a drill down component that provides detailed insights into specific issues and displays in-depth warnings to identify the exact affected code blocks as shown in FIG. 34.

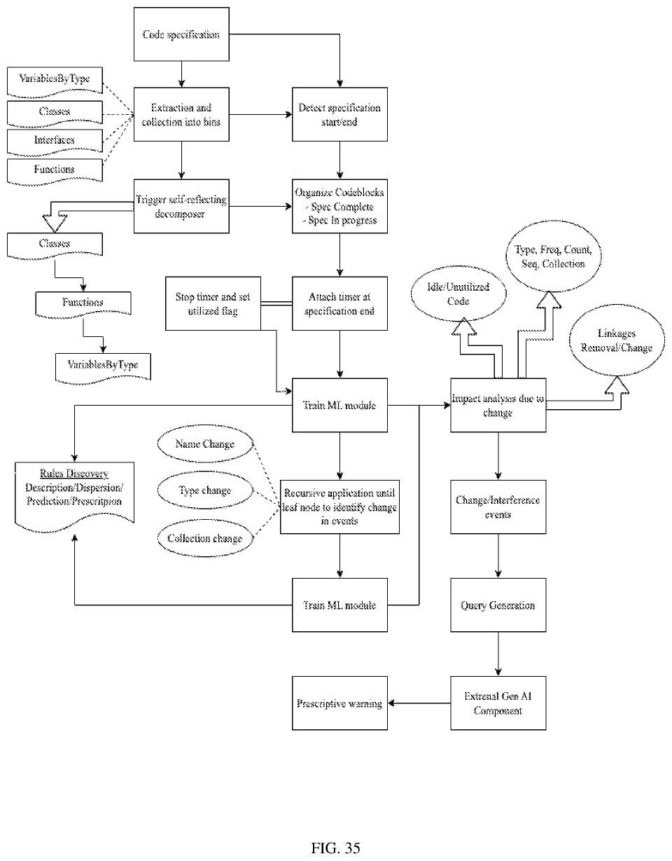

In another embodiment, a process of dynamic code parsing with real-time insights on the quality of the code using a parser integrated with a text editor as shown in FIG. 35 comprises the steps of:
(a) Defining or specifying or introducing all the modules of the parsing component;
wherein the modules include an event generation module, a design time module, a classifier module, a deconstruction module, an analysis module, a ML module, a text generator and a coding style guide;
(b) Typing or dictating or gesturing code specification;
(c) Activation of the classifier module that
   identifies language specific keywords when a user specifies them as per the grammar rules of the language being parsed
   collects the identified keywords into a pool of variables, functions, interfaces, classes and data structure collections including but not limited to lists, arrays and dictionaries, keywords, identifiers, operators, maps, sets and literals;
   filters/extracts and classifies the collected keywords into functional categories including code blocks and its contained components, assignments and conditional checks that is detected by the identification of language specific delimiters, assignment keywords, and comparison operators, respectively;
wherein the contained components include variables, functions, data structure collections including lists, arrays and dictionaries, keywords, identifiers, operators and literals;
wherein the keywords include but not limited to def, function, public, class, interface, extends, super, if, else, elif, for, while, break, continue, int, float, char, list, dict, try, except, catch, and the like;
wherein the language specific delimiters include indentation, curly braces, angle brackets, square brackets, tags and the like;
wherein the comparison operators include logical operators, relational operators and equality operator;
(d) Activation of the event generation module at the start of specification and its subsequent usage as and when reported by the classifier module;
wherein the event generation is based on the trigger definitions specified such as start/end of specification of variable/codeblock, start/end of data type definition, start/end of collection type definitions, start/end of parameter definitions, start/end of outcome variable, type and sequence definitions, start/end of iteration block definition such as but not limited to for/while/do.
(e) Activation of the design time module after the start of an event wherein a timer from the design time module associates with any of the specified functional components and starts timing/scheduling/counting;
(f) Eventual deactivation of the event generation module at the end of specification and its subsequent usage as and when reported by the classifier module and deactivation of the design time module at the event end time and assignment/invocation of the specified functional components;
wherein the end of specification is determined by identification of closing delimiters that matches the opening delimiters including indentation, curly braces, angle brackets, square brackets, tags and the like;
wherein the timer records and reports the lapsed time between specification and usage by storage in the database and subsequent display in the form of a warning;
wherein the timer restarts when the usage of a specified code block and its contained components is revoked or removed;
(g) Activation of the self-reflecting code decomposer and tokenizer from the deconstruction module wherein the deconstruction module decomposes the recently/newly created functional code block, assignments and conditional checks into its components such as functions, parameters including input and output parameters, and variables recursively until a leaf element is encountered;
wherein the recursive application detects any change in event including a name change, type change, and/or collection change;
(h) Parsing the deconstructed code block by the analysis module wherein
the filter segregates the deconstructed code blocks and its contained components based on usage, complete and incomplete specification, interference, redundancies and impactful changes as shown in FIG. 14, and
the analyzer estimates and records the utilization of the segregated code block and/or its contained components, and linkages between functional code blocks by collectively clustering the timer with its associated code block or its contained components and marks each category with a color-coded tag based on frequency of usage, density of linkages and size;
performs impact analysis on the marked code blocks by detecting changes initiated by the user to perform changes in functional components and detects its respective interference in functioning of the impacted code blocks; and
segments code blocks and its contained components in terms of dependency including independent, mutually dependent and/or dependency in one way only;
wherein the changes include name change, or value change, or type change, or collection versus individual change or count change, sequence change or relationship change such as change in containership or association with other data structures or variables or code blocks;
wherein a densely interlinked functional blocks indicates mutual dependence in terms of using each other's functional capabilities and data structures stored in respective variables;
wherein a Sparsely interlinked functional blocks indicates lack of mutual dependence where functional blocks appear to be self-sufficient;
wherein the code blocks that are clustered based on dependency includes completely independent (self-contained), mutually dependent, one way dependence;
(i) Activation of the ML module to learn the sequence, co-occurrence, clustering, correlation and outliers in terms of distribution of associated characteristics including usage, utilization, idle time elapsed, mutual dependencies versus self-contained, size in terms of lines of code, number of variables, parameters and their respective variety in types and proportion of collection objects, while specifying code blocks, and variables along with their respective count, and type, and their usage; interpreting the likelihood of information or functional loss, compilation and/or run-time errors, and/or interference among code blocks and variables by incorporating the impact analysis from step (h) by the ML module and predicting a vulnerability score;
wherein the predicted vulnerability score is directly proportional to the odds ratio;
wherein the independent factors to determine odds ratio include recognition of recurring historical coding patterns pertaining to forced or inadvertent assignments, mismatching I/O parameters in terms of count, type, sequence and whether individual variable or collection of variables, interference in iterative code blocks, uneven referencing burdens on code blocks or variables;
(j) Generation of personalized and prescriptive forewarning and warning texts indicating the potential impact on functional code blocks by the text generator as and when the analysis module performs impact analysis and the ML module interprets the likelihood of errors and predicts the vulnerability score;
wherein the warning texts are retrieved from the database;
wherein the warning texts are generated either by introducing a tool specific programming interface or by abstracted query generator;
(k) Real-time display of the generated warning text, interlinkages of the code blocks and variables depicting the code specified at the time, predictions of issues in a coding construct, and details of the impacted code blocks to the user;
wherein the prescriptive warnings indicating the possibility of committing a mistake in a code construct are presented as augmented prompts from a coding style guide that is generated in real time by feeding query generated by query generator tool either to a commercial generative AI tool or to a third party web service based interface to a language specific help documentation;
wherein the display further includes most frequently and scarcely used functional code blocks, segmented code blocks based on dependency;
wherein the details are displayed in the form of bubbles as shown in FIG. 17 such that the size or radius of bubble is made proportional to the size of its contents,
wherein the details are displayed in the form of charts, and color-coded blocks depending on the demands of the user.

In an example embodiment, a process of dynamic code parsing with real-time insights on the quality of the code using a parsing component is disclosed.
(a) Defining or specifying or introducing all the modules of the parsing component;
(b) Code specification—User types ‘function myFunc (int x, int y) {return x+y;}’.
(c) Classifier module Activation—Identifies ‘function’, ‘int’, ‘return’, and categorizes them into function block and assignments.
(d) Event Generation—Tracks the creation and usage of ‘myFunc’ and its parameters.
(e) Design Time Module—Measures the time from specification completion of ‘myFunc’ until it is used or invoked.
(f) Deconstruction module activation—Breaks down ‘myFunc’ into its components (function name, parameters, return statement).
(g) Analysis module—Clusters ‘myFunc’ based on its usage and dependencies, assesses its impact.
(h) ML Module—Calculates vulnerability score for ‘myFunc’ based on historical patterns of similar functions.
(i) Text Generator—Produces a warning like “Function ‘myFunc’ is unused for 5 minutes. Consider refactoring.”
(j) Real—Time Display-Shows a bubble or chart indicating that ‘myFunc’ is frequently used or has issues.

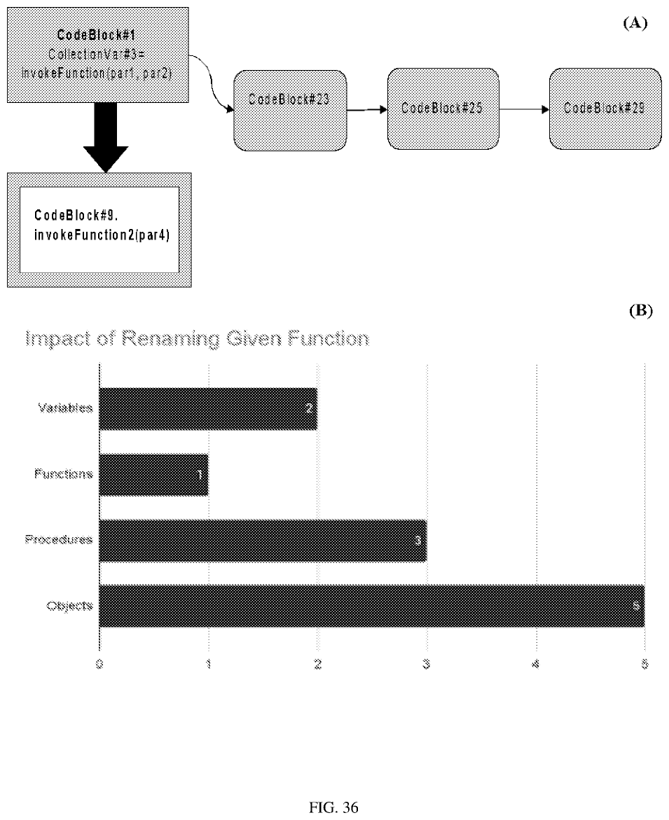

In another example embodiment, a process of event handling and subsequent warning generation of a parser when a function name change impacts one or more code block through interference and linkages as shown in FIG. 36A is disclosed.
(a) Raise event for function name change
(b) Retrieve specification for new function and examine function
(c) Invoke De-constructor on this function to collect Input/Output parameters and contained components recursively until a leaf node such as variable is reached.
(d) Check for name, count, type, sequence and collection mismatch in Input parameters with respect to earlier function/codeblock and raise a name, count, type, sequence and collection mismatch event, respectively.
(e) Check for name, count, type, sequence and collection mismatch in output variables with respect to earlier function/code block and raise a name, count, sequence, type, collection and sequence mismatch event, respectively.
(f) Check for component functional blocks recursively for each code block and repeat steps d-e.
(g) Bundle these event specifications into a collection object.
(h) Retrieve reference chain based on previously established linkages from previously established outbound, and mutual dependence segments for each code block.
(i) Iterate through each of above linkages segments to attach bundle of generated events at specification time based on user actions such as changing variable names, variable types, collection types, sequence of variables or parameters passed/returned from code block for each impacted code block.
(j) Invoke text generator component to display warnings associated with each event for each impacted code block and impact analysis of renaming a function as shown in FIG. 36B.

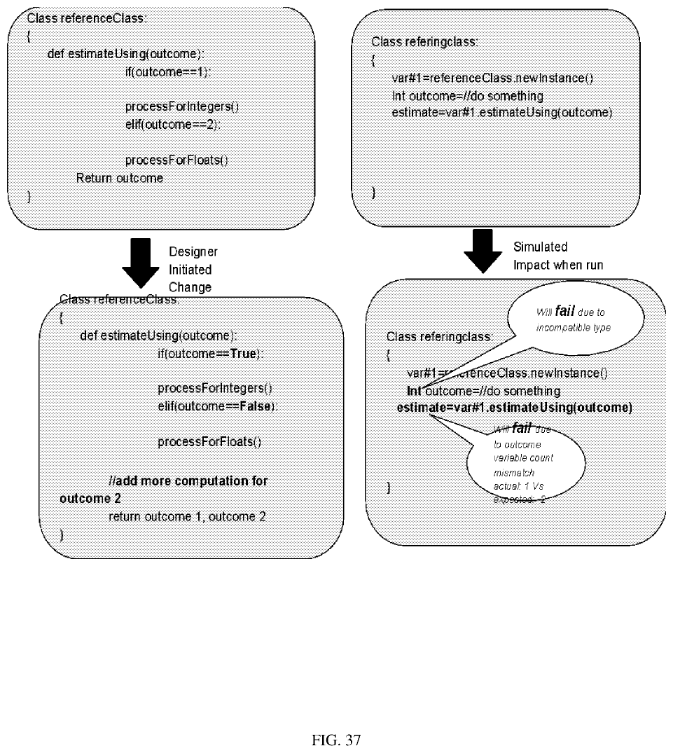

In yet another example embodiment, FIG. 37 showcases the simulation component on how and where a code block with one or more assignment change will fail within one or more references using it. The generated warning texts is intended to enhance designer's understanding of the impact of each change as it is being made during design time and before compilation and running of the program.

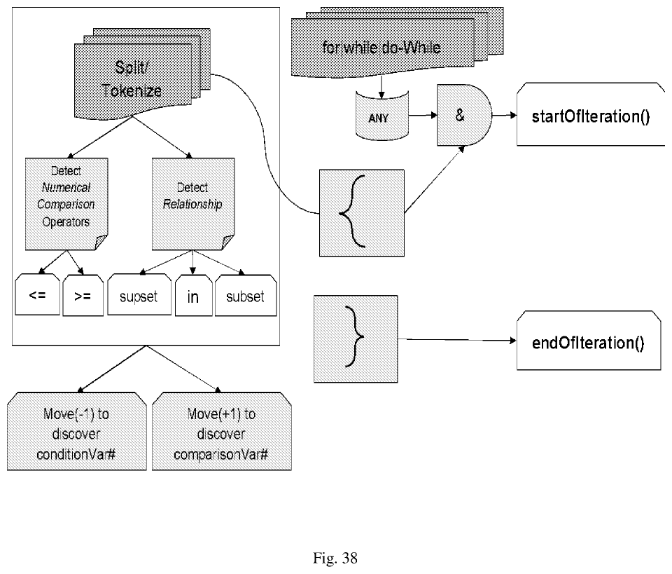

In another example embodiment, FIG. 38 showcases the functionality of real-time deconstructor module that recognizes an iterative block as it is being specified and identifies the type of iteration, controlling variables, the specific condition that is tested in each iteration, and estimate how many iterations are expected to be done normally without any external interference.

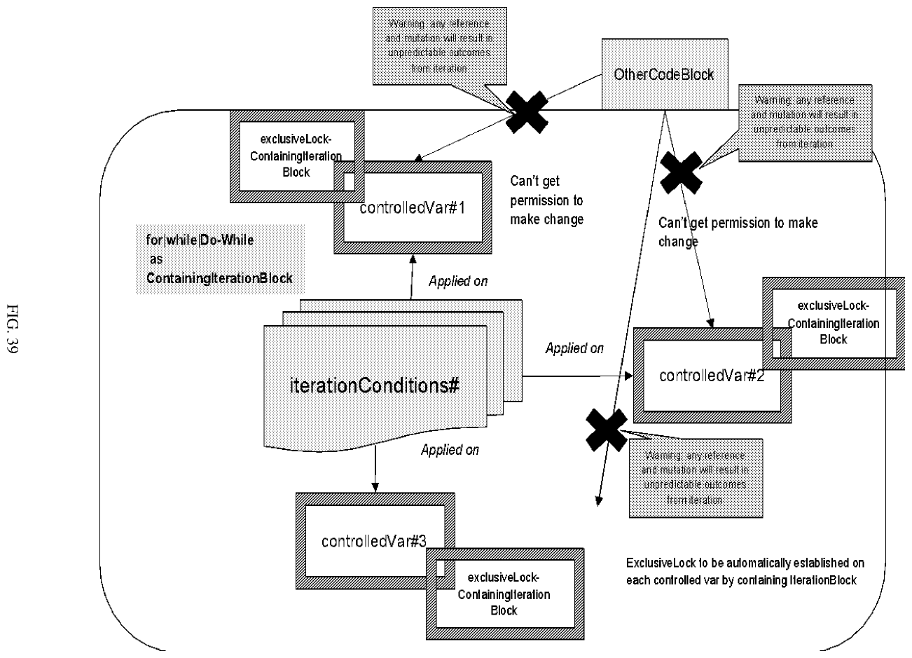

A real-time warning component which detects interfering assignments or modifications in variables impacting iteration behavior inside an iteration code block is shown in FIG. 39.

Thus, the continuous code monitoring parser provides a sophisticated system for enhancing code editors with real-time analysis and feedback capabilities. This system enhances code quality by integrating real-time analysis, predictive insights, and personalized feedback, addressing the gaps in existing code editors and development environments.

The system provides a comprehensive solution for real-time code analysis and feedback, addressing common issues in code development and helping developers improve their coding practices. The system can further be customized to define additional factors or adjust weights based on their specific coding practices and requirements.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

1. A continuous code monitoring parser integrated with a text editor that performs dynamic code parsing and generates real-time insights on the quality of the code comprising:
an event management block including an event generation module and a design time module,
wherein the event generation module further includes an event generator and an event handler that creates and manages events based on code actions;
wherein the design time module further includes one or more timer that is configured to associate with one or more code blocks and its contained components to track their usage;
wherein the timer starts when a syntactical construct is complete and stops as it discovers an assignment or invocation of a code block, or its contained components;
a code analysis block including a classifier module, a deconstruction module and an analysis module,
wherein the classifier module identifies and categorizes language-specific keywords and constructs including code blocks and its contained components as per the grammar rules of the language being parsed;
wherein the deconstruction module further includes
a code decomposer that divides or breaks down a complex code into several small manageable code blocks, and
a tokenizer that breaks down each decomposed code block into several meaningful units and contained components;
wherein the analysis module further includes a filter that segregates the deconstructed code blocks and its contained components based on usage, dependencies, interference, redundancies and impacts, and
an analyzer that estimates the utilization of the segregated code block and/or its contained components by collectively clustering variables or code blocks or its contained components based on the clustering criteria of idle time, or elapsed time since start of specification, or mean time between success usage and marks each category with a color-coded tag;
a prediction block including a ML module that is configured to learn from historical data to predict potential issues and calculate vulnerability score to warn about the potential impact to the user,
wherein the potential issues include likelihood of information loss, functional loss, compilation and/or run-time errors, and/or interference among code blocks and variables;
an output and feedback block including a text generator and a coding style guide,
wherein the text generator generates and displays warnings and prescriptive texts based on analysis and predictions by the analyzation and ML modules, and
the coding style guide further includes a dashboard with dashlets that are created using web server components wherein the frontend and backend components are integrated using IDE;
wherein the said warning texts includes insights retrieved from the impact analysis stored in the database and the coding style guide provides real-time feedback and visualizations of code quality and usage.

2. A continuous code monitoring parser as claimed in claim 1, wherein the ML module uses any known classification algorithm that models and interprets rules regarding code block vulnerabilities, such as name changes or type conflicts and logistic regression that quantifies the probability of errors based on various independent factors;
wherein the independent factors include count of input parameters, count of output parameters, respective types of input and output variables and parameters and number of unique data types, proportion of collection versus individual variables, presence of iteration blocks and historical odds ratio of past errors.

3. A continuous code monitoring parser as claimed in claim 1, wherein the timer also starts when a variable is assigned a value directly or indirectly and restarts when a code block and its contained component is revoked or no longer used until next utilization;
wherein timer will keep running if a component is used within the current session.

4. A process of dynamic code parsing with real-time insights on the quality of the code using a parsing component comprises the steps of:
(a) defining or specifying or introducing all the modules of the parsing components;
wherein the modules include an event generation module, a design time module, a classifier module, a deconstruction module, an analysis module, a ML module, a text generator and a coding style guide;
(b) typing or dictating or gesturing code specification;
(c) identifying language specific keywords by the classifier module when a user specifies them as per the grammar rules of the language being parsed, collect identified keywords into a pool of variables, functions, interfaces, classes and structures and filters/extracts and classifies the collected keywords into functional categories including code blocks and its contained components, assignments and conditional checks;
wherein the keywords include but not limited to def, function, public, class, interface, extends, super, if, else, elif, for, while, break, continue, int, float, char, list, dict, try, except, catch, and the like;
(d) the event generation and corresponding event listener or handler module at the start of specification and its subsequent usage as and when reported by the classifier module;
(e) associating a timer from the design time module after the start of an event with any of the specified functional components and starts timing/scheduling/counting;
(f) stopping the timer at the end of specification and its subsequent usage as and when reported by the classifier module and eventually deactivating the design time module at the event end time and assignment/invocation of the specified functional components;
wherein the end of specification is determined by identification of closing delimiters that matches the opening delimiters including indentation, curly braces, angle brackets, square brackets, tags and the like;
wherein the timer records and reports the lapsed time between ideation and usage by storage in the database and subsequent display in the form of a warning;
wherein the timer restarts when the usage of a specified code block and its contained components is revoked or removed;
(g) activating the self-reflecting code decomposer and tokenizer from the deconstruction module wherein the deconstruction module decomposes the recently/newly created functional code block, assignments and conditional checks into its components such as functions, parameters including input and output parameters, and variables recursively until a leaf element is encountered;
wherein the recursive application detects any change in event including a name change, type change, and/or collection change;
(h) parsing the deconstructed code block by the analysis module wherein the filter segregates the deconstructed code blocks and its contained components based on usage, dependencies, complete and incomplete specification, interference, redundancies and impacts, and
the analyzer estimates and records the utilization of the segregated code block and/or its contained components, and linkages between functional code blocks by collectively clustering the timer with its associated code block or its contained components and marks each category with a color-coded tag based on frequency of usage, density of linkages and size,
(i) performing impact analysis on the marked code blocks by the analyzer such that it detects the changes initiated by user to perform changes in functional components and its respective interference in functioning of the impacted code blocks;
wherein the impact analysis for each change event and assignment or removal of values or linkages includes the forecast of potential unknown variable or code block errors, the identification of reference connections that may be lost due to inadvertent changes, the assessment of potential duplicate or scope conflict issues, the evaluation of possible information or functional loss due to type incompatibilities resulting from the change and the anticipation of potential information or functional loss arising from forced value assignments, removals, or revocations;
and
segments code blocks and its contained components in terms of dependency including independent, mutually dependent and/or dependency in one way only;
wherein the intentions include name change, or value change, or type change, or sequence change or relationship change such as change in containership or association with other data structures or variables or code blocks, or value change;
(j) activating the ML module to learn the sequence, co-occurrence, and correlation of associated timers while specifying code blocks, and variables along with their respective count, and type, and their usage;
(k) interpreting the likelihood of information loss, functional loss, compilation and/or run-time errors, and/or interference among code blocks and variables by incorporating the impact analysis from step (i) by the ML module;
(l) predicting a vulnerability score or likelihood by the ML module wherein the predicted vulnerability score is directly proportional to the odds ratio;
(m) generating personalized and prescriptive forewarning and warning texts by the text generator such that it indicates the potential impact on functional code blocks as and when the analyzation module and the ML module are activated;
wherein the warning texts are retrieved from the database;
wherein the warning texts are generated either by introducing a tool specific programming interface or by abstracted query generator;
(n) displaying the generated warning text, interlinkages of the code blocks and variables depicting the code specified at the time, predictions of issues in a coding construct, and details of the impacted code blocks to the user in real-time.

5. The process of dynamic code parsing with real-time insights as claimed in claim 4,
wherein the code blocks and its contained components, assignments and conditional checks are detected by the identification of language specific delimiters, assignment related keywords including “=” and comparison operators, respectively;
wherein the contained components include variables, functions, data structure collections including but not limited to lists, arrays and dictionaries, maps, sets, keywords, identifiers, operators and literals;
wherein the language specific delimiters include indentation, curly braces, angle brackets, square brackets, tags and the like;
wherein the comparison operators include logical operators, relational operators and equality operator.

6. The process of dynamic code parsing with real-time insights as claimed in claim 4, wherein the independent factors to determine odds ratio include recognition of recurring historical coding patterns pertaining to forced or inadvertent assignments, mismatching I/O parameters in terms of name, count, type, sequence and whether individual variable or collection of variables, interference in iterative code blocks, uneven referencing burdens on code blocks or variables.

7. The process of dynamic code parsing with real-time insights as claimed in claim 4, wherein the prescriptive warnings are presented as augmented prompts from a coding style that is generated in real-time indicating the possibility of committing a mistake in a code construct.

8. The process of dynamic code parsing with real-time insights as claimed in claim 4, wherein
the display further includes most frequently and scarcely used functional code blocks; segmented code blocks based on dependency;
the details are displayed in the form of bubbles such that the size or radius of bubble is made proportional to the size of its contents, and
the details are displayed in the form of charts, and color-coded blocks depending on the demands of the user.
